(19) United States
(12) Patent Application Publication
(10) Pub. No.: US 2012/0021179 A1
(43) Pub. Date: Jan. 26, 2012

(54) INTAKE UNIT

(75) Inventors: Masahiro OHTA, Hamamatsu-shi (JP); Kenji YANO, Hamamatsu-shi (JP)

(73) Assignee: ROKI CO., LTD., Hamamatsu-shi (JP)

(21) Appl. No.: 13/174,965

(22) Filed: Jul. 1, 2011

(30) Foreign Application Priority Data
Jul. 20, 2010 (JP) 2010-162522

(51) Int. Cl. B32B 3/00

(52) U.S. Cl. 428/156

(57) ABSTRACT

An intake unit includes a first member, a second member and a third member, which are manufactured separately and then welded together under application of pressure, wherein a welded portion between the first member and the second member and a welded portion between the second member and the third member are positioned in an overlapped manner, and a first jig receiving surface is formed to the overlapped welded portion between the welded portion between the second member and the first member and the welded portion between the second member and the third member so as to avoid the overlapping therewith.

### BACKGROUND OF THE INVENTION

1. Field of the Invention

The present invention relates to an intake unit, made or resin, composed of three separate members including first, second and third members which are welded by vibration welding process.

2. Related Art

A resin-made intake manifold is conventionally known as a member of part constituting an intake unit or system, which is manufactured by welding a plurality of parts or members through or by vibration welding process. Furthermore, it is desirable to integrally form a tank chamber such as resonator in terms of manufacturing steps, cost and so on in comparison with a method in which a tank chamber is formed separately.

As mentioned, there are known various structures as intake manifolds made of resin in which each of the intake manifold is formed from a plurality of divided or separated parts or members for decreasing manufacturing step and cost increasing even by integrally providing a tank chamber.

One example of such intake manifold is disclosed in Patent Document 1 (Japanese Patent Application Laid-open Publication No. 2004-308604, and the intake manifold of this example is formed so as to project outward of an outer peripheral edge of a first piece, an outer-side welding flange for being welded to a second piece is provided, and a portion of the first piece for being welded to a third piece is provided with an inner-side welding flange projecting toward an inner peripheral side of the peripheral wall section so as to prevent interference to a pressure applying (pressurizing) jig supporting the outer-side welding flange at a welding time between the first piece and the second piece.

The intake manifold disclosed in the Patent Document 1 of the structure mentioned above, the inner-side welding flange of the peripheral wall section is capable of being supported by the pressure applying jig disposed inner peripheral side of the peripheral wall section at the welding time between the first piece and the second piece, and the pressure applying jig has a simple structure not requiring a slidable motion, which result in decreasing in cost, and moreover, the inner-side welding flange can be firmly supported on the inner peripheral side of the peripheral wall section, so that the welding time cannot unnecessarily be elongated, and hence, welding steps or working is not increased.

Furthermore, in another intake manifold such as shown in FIG. 6, after the welding of a port cover 110 to a port 120, a chamber 130 is welded. According to such structure, the weld portion between the port cover 110 and the port 100 and the weld portion between the port 120 and the chamber 130 are overlapped each other at an end of a branch pipe line 112 opposite to another end thereof communicating with a tank chamber 131, and therefore, it is necessary to perform a welding working between the port 120 and the chamber 130 in a state of keeping a separated distance L between a pressure applying jig 141 and a slide jig 142. The reason why such wielding method resides in necessity of abutment of the pressure applying jig 141, which applies pressure and vibration to a work in the vibration-welding process, against the work in the pressurizing direction, and because the slide structure such as slide jig 142 is not adopted, the setting of the separated distance L between the pressure applying jig 141 and the slide jig 142 has been required for effectively applying the pressure and vibration to the work.

According to the structure of the conventional intake manifolds mentioned above, for example, in the intake manifold disclosed in the Patent Document 1, the inner-side welding flange projects inside the branch pipe line, so that it is difficult to ensure a sufficient volume for the intake pipe line, and in addition, the smooth flow of the intake fluid is blocked by the inner-side welding flange, thus providing inconvenient matter.

Moreover, in the intake manifold shown in FIG. 6, the pressure applying jig 141 and the slide jig 142 are separated in location by the distance L, so that it is difficult to apply a sufficient vibration to a portion to be welded, and hence, a stable welding strength cannot be realized, resulting in increasing in welding time.

### SUMMARY OF THE INVENTION

The present invention was therefore conceived in consideration of the circumstances encountered in the prior art mentioned above and an object thereof is to provide an intake unit capable of achieving a stable welding strength and reducing the welding time without forming an inner-side weld flange portion projecting within the branch pipe line even in a case where the welded portion between the port and the port cover and the welded portion between the port and the chamber are overlapped each other.

The above and other objects can be achieved according to the present invention by providing an intake unit composed of a first member, a second member and a third member, which are manufactured separately and then welded together under application of pressure,

wherein a welded portion between the first member and the second member and a welded portion between the second member and the third member are positioned in an overlapped manner, and a first jig receiving surface is formed to the overlapped welded portion between the welded portion between the second member and the first member and the welded portion between the second member and the third member so as to avoid the overlapping therebetween.

In the above aspect, it may be desired that the second member is a port formed with a branch pipe groove, the first member is a port cover provided with a branch pipe line formed by closing the branch pipe groove, and the third member is a chamber communicated with one end of the branch pipe line and provided with a tank chamber formed with an intake port through which an intake fluid is introduced, and wherein the intake unit is an intake manifold. Further, it may be desired that the first jig receiving surface is formed to the port.

Furthermore, it may be desired the first jig receiving surface is formed to one end of the branch pipe groove opposing to another end thereof communicated with the tank chamber, and a rib is formed to the first jig receiving surface so as to project outward of the branch pipe groove in parallel with the welded surface between the port and the chamber.

It may be also desired that a first slide jig receiving portion is formed to the chamber, and the first jig receiving surface and the first slide jig receiving portion are sandwiched and then welded by means of vibration welding jig after the port and the port cover are welded.

It may be further desired that a second slide jig receiving portion is formed to the port and a second jig receiving surface is formed to the port cover, and the second slide jig receiving portion and the second jig receiving surface are sandwiched and then welded by means of vibration welding jig.

Moreover, it may be also desired that the intake unit is a resonator.

In the above preferred embodiment, it is further noted that the above embodiment does not include all the essential features, and sub-combination of these features may constitute an invention.

According to the above aspect of the embodiment of the present invention, the following advantageous effects will be achieved.

In the intake unit according to the present invention, an intake unit is composed of a first member, a second member and a third member, which are manufactured separately and then welded together under application of pressure, wherein a welded portion between the first member and the second member and a welded portion between the second member and the third member are positioned in an overlapped manner, and a first jig receiving surface is formed to the overlapped welded portion between the welded portion between the second member and the first member and the welded portion between the second member and the third member so as to avoid the overlapping therebetween. Therefore, even after the welding between the second member and the first member, the pressure applying jig and the slide jig are not separated in distance, so that sufficient vibration can be applied to a portion to be welded, thus increasing the welding strength and shortening the welding time.

In addition, in the intake unit of the present embodiment, the second member is a port formed with a branch pipe groove, the first member is a port cover provided with a branch pipe line formed by closing the branch pipe groove, and the third member is a chamber communicated with one end of the branch pipe line and provided with a tank chamber formed with an intake port through which an intake fluid is introduced, so that the intake unit is constituted as an intake manifold. Accordingly, in the case when the respective welded portions between the port cover, the port and the chamber are overlapped, there can be provided an intake manifold in which the welding vibration can be sufficiently applied to the respective welded portions, thus improving the welding strength and shortening the welding time.

Furthermore, in the intake unit of the present embodiment, since the first jig receiving surface is formed to the port, the first jig receiving surface is easily formed to a position at which the welded portion between the port and the port cover and the welded portion between the port and the chamber are not overlapped.

Furthermore, in the intake unit of the present embodiment, since the first jig receiving surface is formed to one end of the branch pipe groove opposing to another end thereof communicated with the tank chamber, and a rib is formed to the first jig receiving surface so as to project outward of the branch pipe groove in parallel with the welded surface between the port and the chamber. Accordingly, the pressure applying jig and the slide jig can abut against the outer surface of the intake unit, so that the inner peripheral surface of the branch pipe line is not damaged, at the vibration welding operation, by the pressure applying jig and the slide jig, and it is possible to provide an intake unit prevented from generating any foreign material at the vibration welding operation.

Still furthermore, according to the intake unit of the present embodiment, since the first slide jig receiving portion is formed to the chamber, the port and the chamber can be easily welded after the welding between the port and the port cover.

Still furthermore, according to the intake unit of the present embodiment, since the second slide jig receiving portion is formed to the port and the second jig receiving surface is formed to the port cover, the port and the port cover can be easily welded.

Moreover, since the intake unit of the present embodiment may be formed as a resonator, in the case when the respective welded portions between the first member, the second member and the third member are formed to be overlapped, and there can be provided a resonator in which the welding vibration can be sufficiently applied to the respective welded portions, thus improving the welding strength and shortening the welding time.

The nature and further characteristic features of the present invention will be made clearer from the following descriptions made with reference to the accompanying drawings.

### BRIEF DESCRIPTION OF THE DRAWINGS

In the accompanying drawings:

FIG. 1 is a plan view illustrating an intake unit according to a first embodiment of the present invention;

FIG. 2 is a developed perspective view showing a structure of the intake unit according to the first embodiment of the present invention;

FIG. 3 is a sectional view taken along the line in FIG. 1 for explaining a welding state between a port cover and a port;

FIG. 4 is a sectional view taken along the line for explaining a welding state between a port and a chamber;

FIG. 5 is a plan view illustrating an intake unit according to a second embodiment of the present invention; and

FIG. 6 is a sectional view also taken along the line for explaining a structure of a conventional intake manifold.

### DESCRIPTION OF THE PREFERRED EMBODIMENT

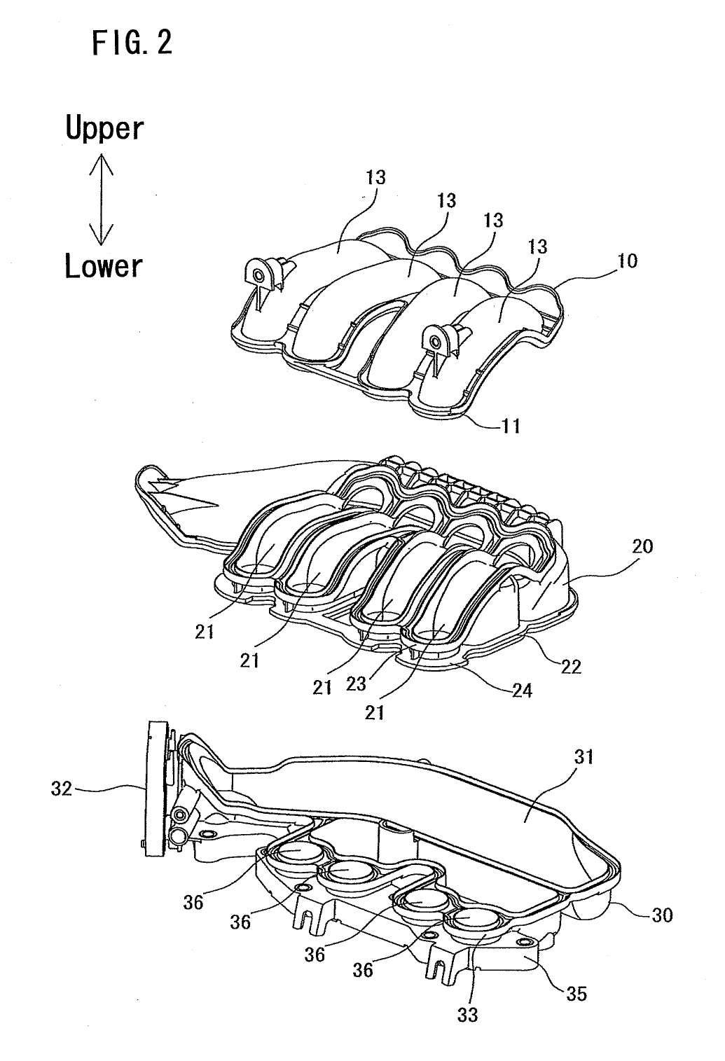

Hereunder, embodiments of the present invention will be explained with reference to the accompanying drawings. Further, it is to be noted that terms “upper”, “lower”, “right”, “left” and like terms showing directions are used herein with reference to the illustration of the drawings, specifically of FIG. 2.

It is also to be noted that the following embodiments do not limit the present invention recited in respective claims, and all the combination of the characteristic features explained in the following embodiments are not essential for the solution of the invention.

It is further to be noted that in the following embodiments, the term “intake unit” is equivalently used as a member or element constituting an intake system, such as intake manifold or resonator, and although the term “member” in first, second and third members constituting the intake unit used hereunder may be substituted with parts or piece, in the present embodiment, they are used as first, second and third members for the sake of convenience for explanation.

### First Embodiment

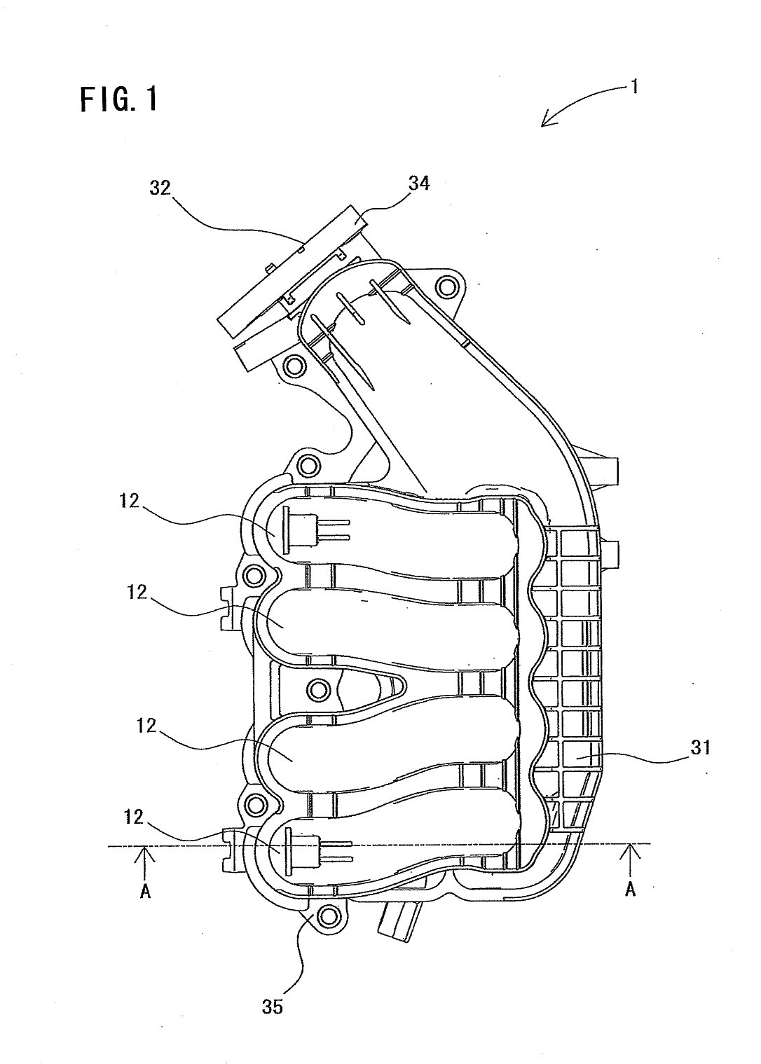

As shown in FIG. 1, an intake unit according to the first embodiment is represented as an intake manifold 1, which is provided with a tank chamber 31 formed with an intake port 32 through which an intake fluid is introduced and branch pipe lines (or merely pipe) 12 for distributing the intake fluid (i.e., fluid taken into the tank chamber 31) into respective cylinders of an internal combustion engine.

The intake manifold 1 of this embodiment is an intake manifold used for an inline four-cylinder engine, and hence, the four branch pipe lines 12 are equally formed. The intake port 32 is opened to the flanged portion 34 of the end portion of the tank chamber 31, and the intake manifold 1 is mounted to a throttle body for controlling intake fluid, not shown, through the flanged portion 34. One end of each of the branch pipe lines 12 opposing to the other one end continuous to the tank chamber 31 is formed with a flanged portion 35 of the internal combustion engine, not shown.

With reference to FIG. 2, the structure of the intake manifold 1 according to the present embodiment will be described hereunder in detail.

As shown in FIG. 2, the intake manifold 1 of this embodiment includes a port 20 as a second member (parts or piece) to which a branch pipe groove 21, a port cover 10 as a first member (parts or piece) closing the branch pipe groove 21 to form the branch pipe line 12, and a chamber 30 as a third member (parts or piece) to which the tank chamber 31 is formed and a drain port 36 is also formed for introducing the intake fluid into the internal combustion chamber.

The port 20 is arranged so as to be sandwiched between the port cover 10 which is to be welded to an upper side thereof and the chamber 30 which is to be welded from the lower side thereof in the manner such that the port cover 10, the port 20 and the chamber 30 are welded in an overlapped manner from the upper side in this order. Further, the port cover 10, the port 20 and the chamber 30 are welded are all formed of a thermoplastic synthetic resin such as polyamide series resin or polypropylene series resin, and friction heat is generated by means of vibration to the weld surfaces of the respective members, which are then welded while applying pressure by a pressure applying jig or slide jig. Furthermore, the intake manifold 1 of the present embodiment is formed such that the welded portions of the port cover 10, the port 20 and the chamber 30 are overlapped each other in the vertical direction on the drain port side 36 of the branch pile lines 12.

The port cover 10 is formed with closing portions 13 so as to form an upper surface of the branch pipe lines 12 so as to close the opening of the branch pipe grooves 21, respectively, and a second jig receiving surface 11 to be welded with the port 20 is formed to the outer peripheral edge of the port cover 10.

As mentioned hereinabove, the port 20 is formed with the branch pipe grooves 21 for communicating the tank chamber 31 with the drain ports 36, and a second slide jig receiving portion 23 to be welded to the port cover 10 is formed to the outer peripheral edge of each of the branch pipe grooves 21, and a first jig receiving surface 22 to be welded to the chamber 30 is formed to the outer peripheral edge of the lower end portion of the port 20.

Furthermore, the first jig receiving surface 22 is formed, on the drain port side 36 of the branch pipe groove 21, with a rib 24 in parallel with the welded surface between the port 20 and the chamber 30 and protruding outward of the branch pipe groove 21 so as to avoid the overlapping of the welded portion between the port cover 10 and the port 20 and the welded portion between the port 20 and the chamber 30.

The chamber 30 is formed with an intake port 32 communicating with the tank chamber 30 and drain ports 36 communicating with the branch pipe lines 12. Furthermore, a first slide jig receiving portion 33 to be welded to the port 20 is formed to the outer peripheral edges of the tank chamber 31 and the drain ports 36.

Accordingly, as mentioned above, the port cover 10 and the port 20 are welded each other by the vibration welding between the second jig receiving surface 11 and the second slide jig receiving portion 23, and on the other hand, the port 20 and the chamber 30 are welded each other by the vibration welding between the first jig receiving surface 22 and the first slide jig receiving portion 33.

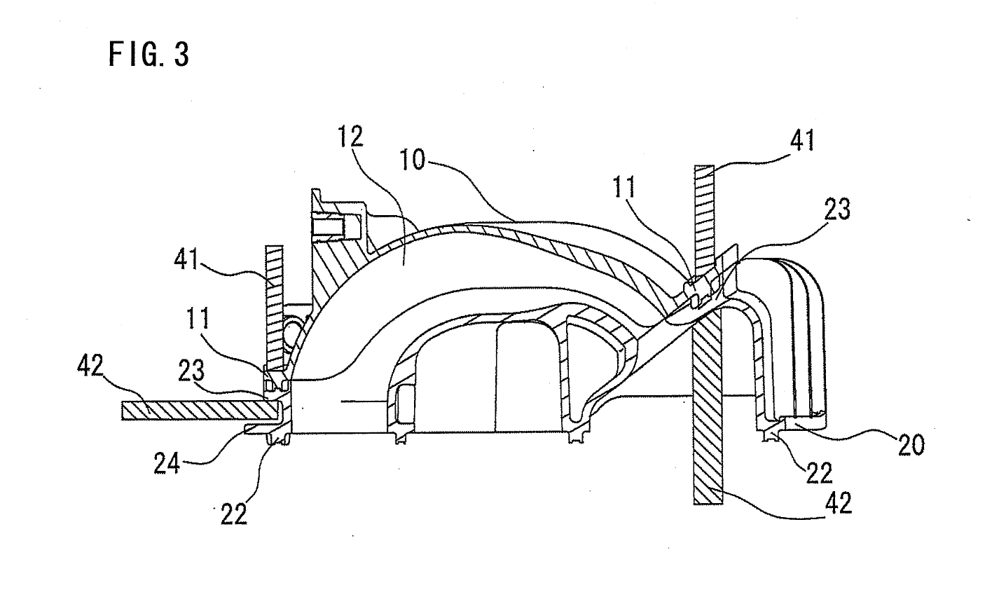

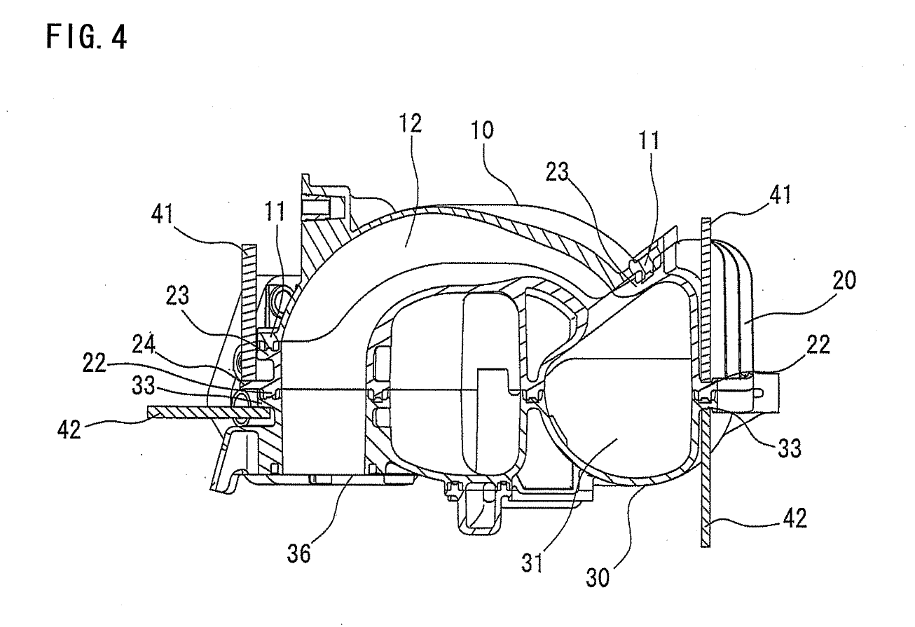

The intake manifold 1 according to the present embodiment will be manufactured in the manner mentioned hereunder with reference to FIGS. 3 and 4.

In the method of manufacturing the intake manifold 1 of the present embodiment, the port cover 10 and the port 20 are first welded by means of vibration welding process. As shown in FIG. 3, this vibration welding is performed in a state such that the lower end portion of the port cover 10 and the upper end portion of the port 20 are overlapped, the lower end portion of the second slide jig receiving portion 23 is supported by the slide jig 42, and the pressure and vibration are then applied from the upper end portion of the second jig receiving surface 11 by the pressure applying jig 41. In the vibration welding, the weld projected portion formed to the second jig receiving surface 11 is fused by the friction heat generated by the vibration and the pressure applying jig 41 pressurizes the second jig receiving surface 11 against the second slide jig receiving portion 23, thus performing the welding process.

After the welding between the port cover 10 and the port 20, the port 20 and the chamber 30 are welded together as shown in FIG. 4. This vibration welding is performed in a state such that the lower end portion of the port 20 and the upper end portion of the chamber 30 are overlapped, the lower end portion of the first slide jig receiving portion 33 is supported by the slide jig 42, and the pressure and vibration are then applied from the upper end portion of the first jig receiving surface 22 by the pressure applying jig 41, thus performing the welding process. In this vibration welding, as mentioned hereinbefore, since the welded portion between the port cover 10 and the port 20 and the welded portion between the port 20 and the chamber 30 are overlapped in the vertical direction, the drain port 36 side of the branch pipe line 12 abuts against the rib 24 formed to the first jig receiving surface 22 by the pressure applying jig 41, thus performing the vibration welding between the port 20 and the chamber 30.

As explained above, the intake manifold 1 according to the described embodiment, the ribs 24 formed to the first jig receiving surface 22 is formed in a projected manner so as to avoid the overlapping between the respective welded portions at which the welded portion between the port cover 10 and the port 20 and the welded portion between the port 20 and the chamber 30 are overlapped, so that, even after the welding between the port cover 10 and the port 20, sufficient pressure and vibration can be applied to the welded portion between the port 20 and the chamber 30, thus realizing the stable welding strength and reduction in the welding time.

Hereinabove, although the description was made to the intake manifold constructed as an intake unit according to the first embodiment, the intake unit according to the present invention is not limited to such intake manifold, and hence, another embodiment of the intake unit according to the present invention may be formed as a resonator, which will be described hereunder.

### Second Embodiment

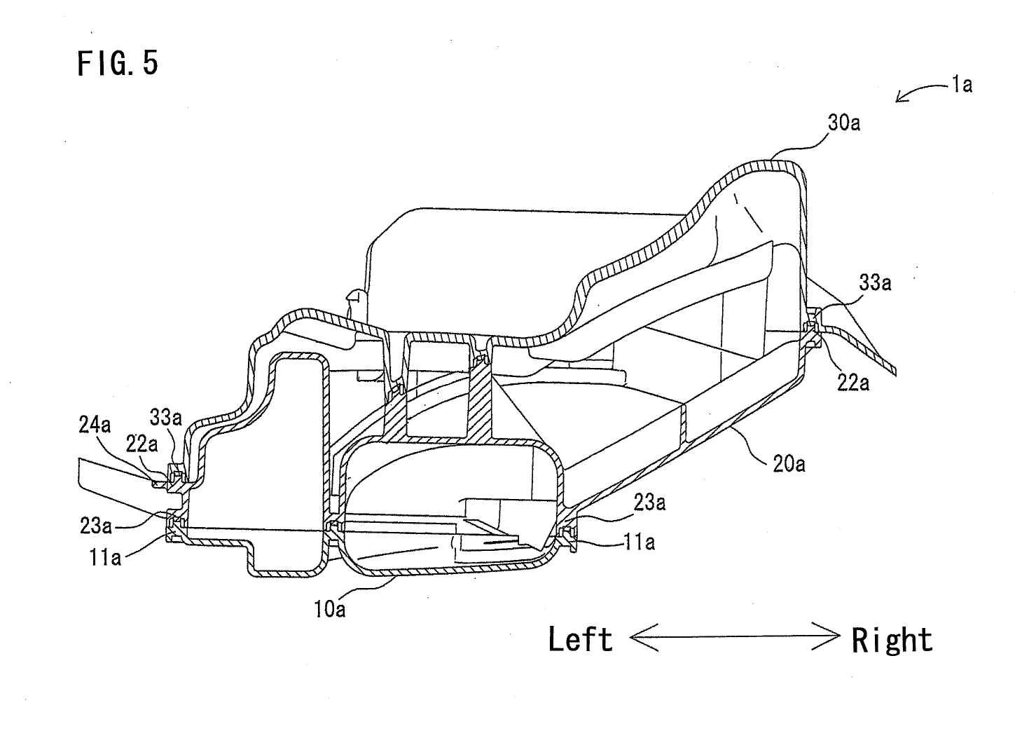

FIG. 5 is a sectional view for explaining the intake unit according to the second embodiment. Further, it is to be noted that the same reference numerals are added to members or portions corresponding to the same or similar ones constituting the intake unit as the first embodiment mentioned above and explanations thereof are hence omitted herein, and in the description with reference to FIG. 5, the width direction of the drawing is prescribed as lateral (right-and-left) direction.

As shown in FIG. 5, the intake unit according to this embodiment has a structure of a resonator 1a. The resonator 1a is a member utilized in connection with an intake system of an internal combustion engine so as to act to reduce intake noise generated at a time of introducing air from ambient atmosphere.

The resonator 1a has a housing constituting an outer casing, and the housing is composed of a cover 30a as a third member (parts or piece) constituting an upper half of the resonator 1a, a case 20a as a second member (parts or piece) constituting a lower half of the resonator 1a and an under case as a third member (parts or piece) closing the lower end of the case 20a.

The case 20a is positioned so as to sandwiched between the cover 30a which is welded to an upper side of the case 20a and the under case 10a which is welded to a lower side thereof in an arrangement in which the cover 30a, the case 20a and the under case 10a are welded in an overlapped manner in this order from the upper side. The cover 30a, the case 20a and the under case 10a are formed of a thermoplastic synthetic resin such as polyamide series resin or polypropylene series resin, and friction heat is generated to surfaces of these members to be welded by the vibration and then welded while applying pressure to these members by means of pressure applying jig or slide jig. Furthermore, in the resonator la of this embodiment, the welded portions of the cover 30a, the case 20a and the under case 10a are formed so as to be overlapped in the vertical direction at the left end side in FIG. 5.

The cover 30a has an opened lower end portion as an opening, and a first slide jig receiving portion 33a to be welded to the case 20a is formed to an outer peripheral edge of the opening.

Further, a first jig receiving surface 22a to be welded to the cover 30a is formed to an outer peripheral edge of an upper end of the case 20a, and a second slide jig receiving portion 23a to be welded to the under case 10a is also formed to an outer peripheral edge of an lower end of the case 20a. Furthermore, a rib 24a projecting outward in the same direction as the first jig receiving surface 22a is formed on the left end side so as to avoid the overlapping of the welded portion between the under case 30a and the case 20a to the welded portions between the case 20a and the cover 30a.

A second jig receiving surface 11a to be welded to the case 20a is further formed to an outer peripheral edge of an upper end portion of the under case 10a.

As mentioned hereinabove, the under case 10a and the case 20a are welded together by the vibration welding applied to the second jig receiving surface 11a and the second slide jig receiving portion 23a, and on the other hand, the case 20a and the cover 30a are also welded together by the vibration welding applied to the first jig receiving surface 22a and the first slide jig receiving portion 33a.

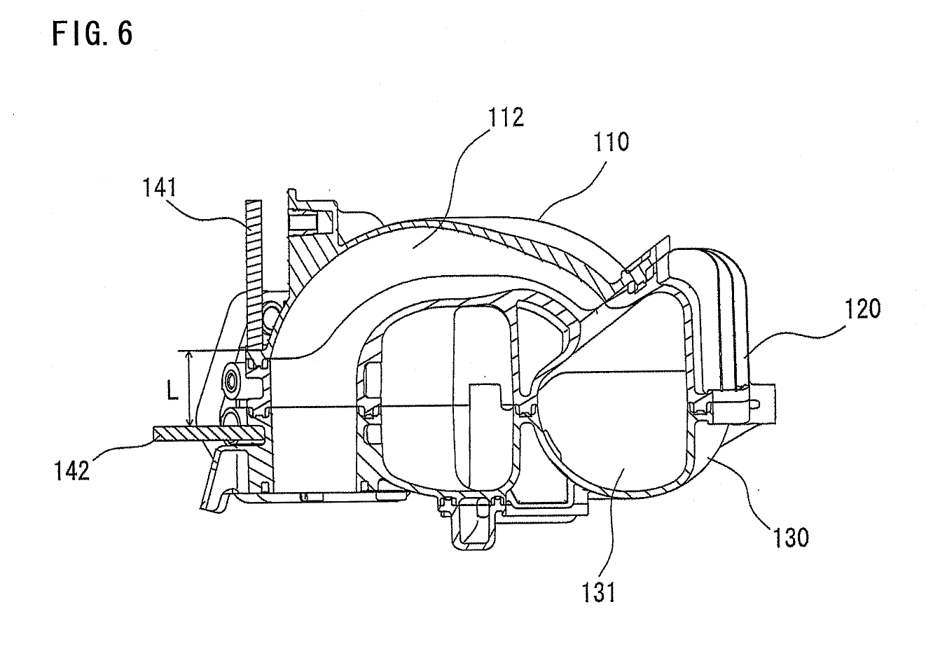

With the resonator la according to this second embodiment, the welding is performed to the case 20a and the cover 30a after the welding between the under case 10a and the case 20a. That is, the vibration welding is performed under the state that the upper end portion of the case 20a and the lower end portion of the cover 30 are overlapped each other, the upper end portion of the first slide jig receiving portion 33a is supported by the slide jig, and the pressure and the vibration are applied by the pressure applying jig from the lower end portion of the first jig receiving surface 22. In this operation, as mentioned above, on the left end side in FIG. 6, the welded portion between the under case 10a and the case 20a and the welded portion between the case 20a and the cover 30a are overlapped in the vertical direction, so that the pressure applying jig abuts against the rib 24a formed to the first jig receiving surface 22, thereby performing the vibration welding between the case 20a and the cover 30a.

As mentioned above, according to the resonator 1a of the present embodiment, the ribs 24a formed to the first jig receiving surface 22a are formed in a projecting manner so as to avoid the overlapping between the respective welded portions at which the welded portion between the under caser 10a and the case 20a and the welded portion between the case 20a and the cover 30a are overlapped, so that, even after the welding between the under case 10a and the case 20a, sufficient pressure and vibration can be applied to the welded portion between the case 20a and the cover 30a, thus realizing the stable welding strength and reduction in the welding time.

Furthermore, although, in the above embodiments, the intake manifold 1 of the type applicable to an inline four-cylinder internal combustion engine was described, the present invention is not limited to this type internal combustion engine and also applicable to an inline six-cylinder internal combustion engine, and in such type cylinder, a structure including six branch pipe lines may be arranged. Thus, the shape and number of the branch pipe line(s) may be added or reduced optionally in accordance with types of an internal combustion engine to which the present invention is applied, and such change or modified embodiment may be also included within the technical scope of the present invention, which will be made clearer from the appended claims.

What is claimed is:

1. An intake unit composed of a first member, a second member and a third member, which are manufactured separately and then welded together under application of pressure,
wherein a welded portion between the first member and the second member and a welded portion between the second member and the third member are positioned in an overlapped manner, and a first jig receiving surface is formed to the overlapped welded portion between the welded portion between the second member and the first member and the welded portion between the second member and the third member so as to avoid the overlapping therebetween.

2. The intake unit according to claim 1, wherein the second member is a port formed with a branch pipe groove, the first member is a port cover provided with a branch pipe line formed by closing the branch pipe groove, and the third member is a chamber communicated with one end of the branch pipe line and provided with a tank chamber formed with an intake port through which an intake fluid is introduced, and wherein the intake unit is an intake manifold.

3. The intake unit according to claim 2, wherein the first jig receiving surface is formed to the port.

4. The intake unit according to claim 3, wherein the first jig receiving surface is formed to one end of the branch pipe groove opposing to another end thereof communicated with the tank chamber, and a rib is formed to the first jig receiving surface so as to project outward of the branch pipe groove in parallel with the welded surface between the port and the chamber.

5. The intake unit according to claim 4, wherein a first slide jig receiving portion is formed to the chamber, and the first jig receiving surface and the first slide jig receiving portion are sandwiched and then welded by means of vibration welding jig after the port and the port cover are welded.

6. The intake unit according to claim 5, wherein a second slide jig receiving portion is formed to the port and a second jig receiving surface is formed to the port cover, and the second slide jig receiving portion and the second jig receiving surface are sandwiched and then welded by means of vibration welding jig.

7. The intake unit according to claim 1, wherein the intake unit is a resonator.
